(19) United States
(12) Patent Application Publication
(10) Pub. No.: US 2007/0091303 A1
(43) Pub. Date: Apr. 26, 2007

(54) Device for detecting contamination of lens in exposure device

(75) Inventor: Jin Youp Kim, Seocho-gu (KR)

Correspondence Address: MCKENNA LONG & ALDRIDGE LLP, 1900 K STREET, NW, WASHINGTON, DC, 20006, US

(73) Assignee: DongbuAnam Semiconductor Inc., Seoul (KR)

(21) Appl. No.: 11/320,738

(22) Filed: Dec. 30, 2005

(30) Foreign Application Priority Data
Oct. 20, 2005 (KR) 10-2005-0099180

(51) Int. Cl. G01N 21/00

(52) U.S. Cl. 356/239.8

(57) ABSTRACT

A device for detecting contamination of a lens in an exposure device in which a sample for detecting contamination is formed of the same material as that of the lens and transmittance of the sample is detected to sense a contamination level of the lens.

### CROSS REFERENCE TO RELATED APPLICATION

This application claims the benefit of the Korean Patent Application No. P2005-0099180, filed on Oct. 20, 2005, which is hereby incorporated by reference for all purposes as if fully set forth herein.

### BACKGROUND OF THE INVENTION

1. Field of the Invention

The present invention relates to an exposure device, and more particularly, to a device for detecting contamination of a lens in an exposure device, which can detect a contamination level of the lens fixed to the exposure device.

2. Discussion of the Related Art

Typically, a semiconductor device has a multilevel structure comprised of various films such as a silicon film, an oxide film, a field oxide film, a polysilicon film, and metal line film. A multilevel semiconductor device is manufactured by various process steps such as a deposition process, an oxidation process, a photolithographic process (processes of coating, exposing and developing a photoresist film), an etching process, a cleaning process, and a rinsing process.

To selectively pattern a material layer deposited, a photoresist film is coated on the material layer by spin coating and then irradiated through a mask to undergo an exposure process. Afterwards, the photoresist film is developed to form a desired photoresist mask pattern on the material layer. The material layer is then selectively removed (etched) using the photoresist mask pattern as a mask to obtain a desired pattern.

As described above, to expose the photoresist film using a mask, an exposure device is necessarily required.

FIG. 1 is a sectional view illustrating a related art exposure device.

As shown in FIG. 1, the related art exposure device includes a wafer stage 4 supporting a wafer 5 coated with a photoresist, a light source 10 emitting UV light, a focusing lens 1 concentrating the light emitted from the light source 10, a reticle 2 (or mask) provided with a light-transmitting region and a light-shielding region in a desired shape to selectively transmit the light emitted from the condenser lens 1, and a projection lens system 3 focusing the light from the reticle 2 at a certain size to irradiate the light onto the wafer 5 arranged on the wafer stage 4.

If an exposure process is performed using the aforementioned exposure device, the light emitted from the light source 10 is projected by the lens system 3 after passing through the condenser lens 1 and the reticle 2, thereby exposing the wafer coated with the photoresist. Thus, a pattern formed on the reticle 2 is transferred onto the photoresist on the wafer.

The exposed photoresist has an irradiated portion and a non-irradiated portion. If the photoresist is developed using a developer, the irradiated portion and the non-irradiated portion are selectively patterned.

However, when the wafer is exposed using the described exposure device, the lens of the exposure device may be contaminated by amine (compound obtained by substituting hydrocarbon radical for hydrogen atom of ammonia), organic compounds, and so on.

Materials excreted from a human body, amine, and organic compounds used for the process of the semiconductor device are diffused in the air in a manufacture line of the semiconductor device, thereby contaminating the air. The contaminated air enters the exposure device. The contaminated materials react the lens because of the UV light during the exposure process. For this reason, the lens of the exposure device becomes contaminated.

FIG. 2 illustrates that the lens is contaminated by amine and organic compounds.

As described above, amine and organic compounds are caused to react with the lens by the UV light during the exposure process to form a rough surface of the lens and generate a new material. The new material is attached to the surface of the lens. For this reason, transmittance of the lens is reduced, and an undesired pattern is formed during the photolithographic process.

To prevent the amine and the organic compounds from entering the exposure device, a chemical filter has been conventionally used. Also, the exposure device is provided with a separate device that monitors the concentration of the amine and the concentration of the organic compounds and to display them. However, the exposure device is not separately provided with a device for detecting a contamination level of the lens.

The related art exposure device and the related art exposure method have the following disadvantages.

First, since the manufacture line of the semiconductor device is fully operated, it is difficult to frequently clean the exposure device. If a cleaning time period of the lens passes, the lens should be replaced with a new one. This leads to additional cost.

In addition, if the cleaning time period of the lens passes, the exposure process is performed using the contaminated lens. This results in the resolution of the pattern formed on the wafer being reduced and thus cause a defect in the pattern.

### SUMMARY OF THE INVENTION

Accordingly, the present invention is directed to a device for detecting contamination of a lens in an exposure device, which substantially obviates one or more problems due to limitations and disadvantages of the related art.

An advantage of the present invention is that it provides a device for detecting contamination of a lens in an exposure device, in which a sample for detecting contamination is formed of the same material as that of the lens and transmittance of the sample is detected to sense a contamination level of the lens.

Additional advantages, and features of the invention will be set forth in part in the description which follows, and will become apparent from the description, or may be learned by practice of the invention. These and other advantages of the invention may be realized and attained by the structure particularly pointed out in the written description and claims hereof as well as the appended drawings.

To achieve these and other advantages and in accordance with the purpose of the invention, as embodied and broadly described herein, in an exposure device having a light source and the lens to expose a photoresist, a device for detecting contamination of the lens in the exposure device includes a sample for detecting contamination, formed of the same material as that of the lens and arranged in a path of the light source to react with amine or organic compounds in the air, a sensor sensing transmission of the light from the sample, and a controller analyzing transmittance of the light sensed by the sensor to detect a contamination level of the lens.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiment(s) of the invention and together with the description serve to explain the principles of the invention. In the drawings:

FIG. 1 is a sectional view illustrating a related art exposure device;

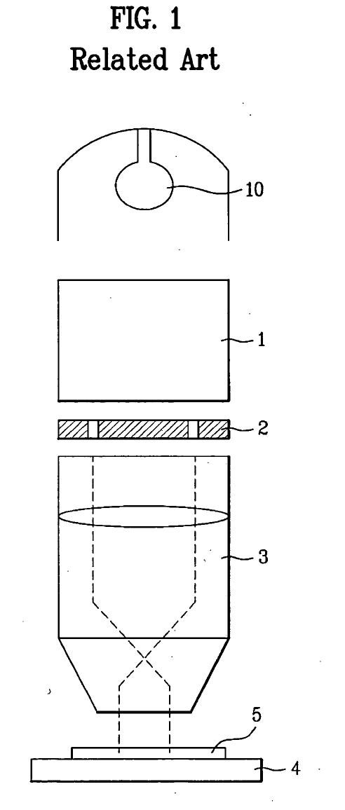

FIG. 2 illustrates contamination of a lens in a related art exposure device; and

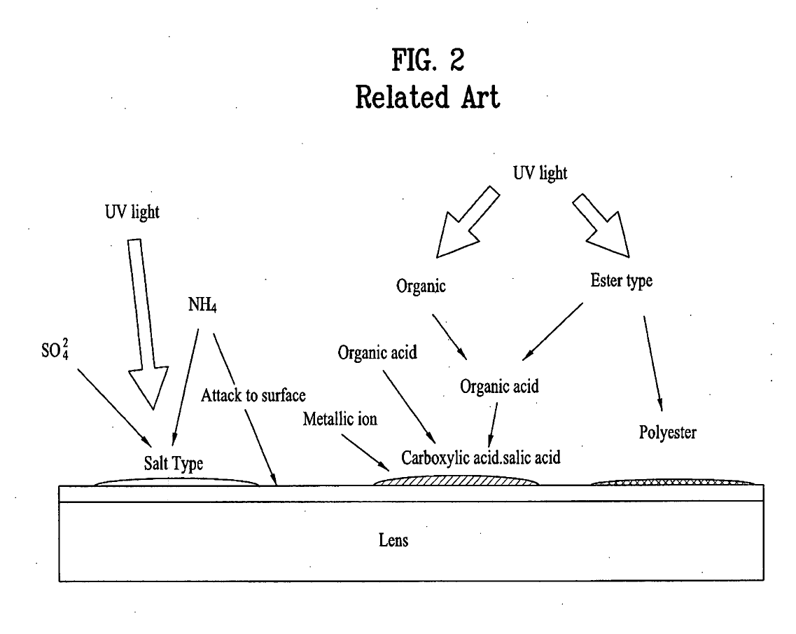

FIG. 3 is a sectional view illustrating a device for detecting contamination of a lens in an exposure device according to an exemplary embodiment of the present invention.

### DETAILED DESCRIPTION OF THE INVENTION

Reference will now be made in detail to exemplary embodiments of the present invention, examples of which are illustrated in the accompanying drawings. Wherever possible, the same reference numbers will be used throughout the drawings to refer to the same or like parts.

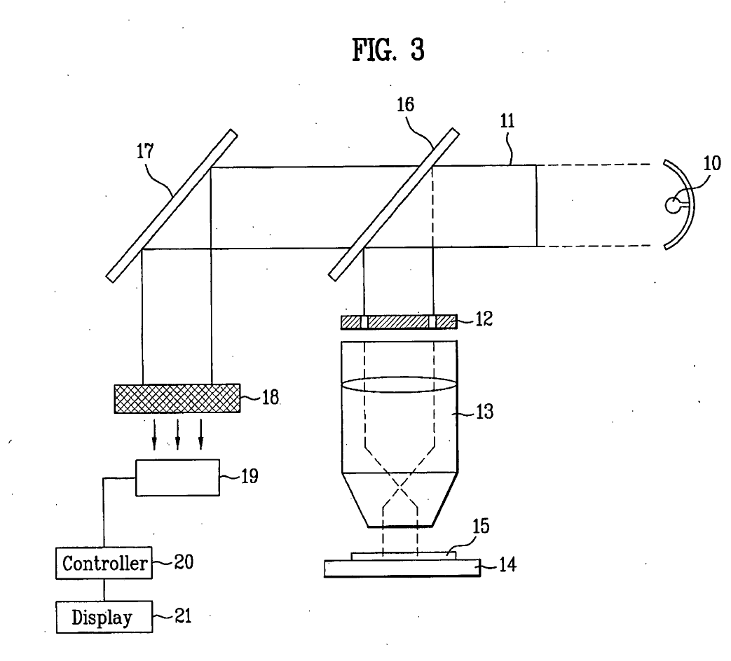

FIG. 3 is a sectional view illustrating a device for detecting contamination of a lens in an exposure device according to an exemplary embodiment of the present invention.

As shown in FIG. 3, a device for detecting contamination of a lens in an exposure device according to an exemplary embodiment of the present invention includes a wafer stage 14 supporting a wafer 15 coated with a photoresist, a light source 10 emitting UV light, a condenser lens 11 condensing the light emitted from the light source 10, a dichromic mirror 16 partially reflecting and transmitting the light emitted from the condenser lens 11, a reticle 12 (or mask) provided with a light-transmitting region and a light-shielding region in a desired pattern to selectively transmit the light reflected by the dichromic mirror 16, a projection lens system 13 focusing the light from the reticle 12 at a certain size to irradiate the light onto the wafer 15 arranged on the wafer stage 14, a mirror 17 selectively reflecting the light transmitted by the dichromic mirror 16, a sample 18 for detecting contamination, formed of the same material (for example, SiO₂ glass) as that of the condenser lens 11 or the projection lens system 13 and arranged in a path of the light reflected by the mirror 17 to be contaminated by amine or organic compounds under the same condition as that of the lens, a sensor 19 sensing the transmission of light from the sample 18, and a controller 20 analyzing the transmittance of light sensed by the sensor 19 to detect a contamination level of the lens and displaying the contamination level.

Since the mirror 17 is not an essential element of the present invention, it is optional. A photodiode, a photo transistor or a photo coupler is used as the sensor 19.

The light irradiated to the sample 18 is not separately formed by the dichromic mirror 17. The light used to detect the position of the wafer 15 or align the wafer 15 in the exposure device may be used.

A method for detecting contamination of a lens in the aforementioned device according to an exemplary embodiment of the present invention will be described.

If an exposure process is performed, the light emitted from the light source 10 is focused through the condenser lens 11, and is partially reflected and transmitted by the dichromic mirror 16. The light reflected by the dichromic mirror 16 transmits the projection lens system 13 after passing through the reticle 12, thereby exposing the wafer 15 coated with photoresist. Thus, a pattern formed on the reticle 12 is transferred onto the photoresist on the wafer 15. At the same time, the light transmitted by the dichromic mirror 16 is irradiated into the sample 18, optionally, through the mirror 17.

Because the sample 18 has the same condition as that of the lens, it is contaminated by the amine and the organic compounds in the same manner as the lens. For this reason, transmittance of the sample is deteriorated like that of the lens. Therefore, the sensor 19 senses transmittance of the sample 18 and the controller 20 analyzes the sensed transmittance to sense the contamination level of the lens. The contamination level is displayed in a display 21, so that a worker can clean the exposure device depending on the contamination level displayed in the display 21.

As described above, the device for detecting contamination of a lens in an exposure device according to an exemplary embodiment of the present invention has the following advantages.

Since the sample for detecting contamination is formed in the exposure device of the same material as that of the lens, it is possible to sense and display the contamination level of the lens by analyzing transmittance of the sample. Therefore, the worker can timely clean the lens. As a result, even though the manufacture line of the semiconductor device is fully operated, it is possible to timely clean the lens of the exposure device. Thus, it is possible to prevent the lens from being damaged and exchanged with a new one due to lapse of a cleaning time period of the lens.

Moreover, since the cleaning time period of the lens is sensed, it is possible to prevent a defect of the pattern from being caused by contamination of the lens.

It will be understood to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A device for detecting contamination of a lens in an exposure device, the exposure device having a light source and the lens to expose a photoresist, the device comprising:
a sample for detecting contamination, formed of the same material as that of the lens and arranged in a path of the light source to react with amine or organic compounds in the air;
a sensor sensing transmission of the light from the sample; and
a controller analyzing transmittance of the light sensed by the sensor to detect a contamination level of the lens.

2. The device as claimed in claim 1, further comprising a display displaying the contamination level of the lens under the control of the controller.

3. The device as claimed in claim 1, wherein the sample is formed of a SiO₂ glass.

4. A device for detecting contamination of a lens in an exposure device comprising:
a wafer stage arranging a wafer coated with a photoresist;
a light source emitting light;
a condenser lens condensing the light emitted from the light source;
a dichromic mirror partially reflecting and transmitting the light emitted from the condenser lens;
a reticle provided with a light-transmitting region and a light-shielding region to selectively transmit the light reflected by the dichromic mirror;
a projection lens system condensing the light from the reticle at a certain size to irradiate the light onto the wafer arranged on the wafer stage;
a sample for detecting contamination, formed of the same material as that of the condenser lens or the projection lens system and arranged in a path of the light reflected by the dichromic mirror to be contaminated by amine or organic compounds under the same condition as that of the lens;
a sensor sensing transmission of the light from the sample; and
a controller analyzing transmittance of the light sensed by the sensor to detect a contamination level of the lens and displaying the contamination level.

5. The device as claimed in claim 4, wherein the sample is formed of a SiO₂ glass.

6. The device as claimed in claim 4, further comprising a mirror reflecting the light transmitted by the dichromic mirror toward the sample.

7. A method for detecting contamination of a lens in an exposure device comprising:
transmitting a light through a sample and the lens wherein the sample is formed of the same material as the lens; and
analyzing the light transmitted through the sample element.

8. The method of claim 7, wherein the sample element is formed of SiO₂.

9. The method of claim 7, wherein transmitting the light toward the sample element comprises:
partially reflecting and transmitting the light transmitted through the lens toward the sample element using a dichromic mirror.

10. The method of claim 7, wherein the light transmitted through the lens is the same light transmitted through the sample.
